(19) United States
(12) Patent Application Publication
(10) Pub. No.: US 2019/0032531 A1
(43) Pub. Date: Jan. 31, 2019

(54) ENGINE AND ENGINE WORK MACHINE

(71) Applicant: Koki Holdings Co., Ltd., TOKYO (JP)

(72) Inventor: Tatsuya HAGAWA, Ibaraki (JP)

(73) Assignee: Koki Holdings Co., Ltd., TOKYO (JP)

(21) Appl. No.: 16/073,801

(22) PCT Filed: Jan. 6, 2017
(86) PCT No.: PCT/JP2017/000277

§ 371 Date: Jul. 29, 2018

(30) Foreign Application Priority Data
Jan. 30, 2016 (JP) 2016-016745

(51) Int. Cl. F01N 1/08; F01N 3/28; F01N 13/18; F01N 13/16; F02B 63/02

(52) U.S. Cl. CPC F01N 1/08; F01N 3/2885; F01N 2230/04; F01N 13/16; F02B 63/02; F01N 13/1833

(57) ABSTRACT

Provided are an engine and an engine work machine. An engine in which a substantially box-shaped muffler made by joining a partitioning plate with inner and outer housings is directly secured to a cylinder, wherein the center axis of the cylinder is slanted rearward at an angle. The muffler has the partitioning plate inclined from the cylinder-side upper corner part toward the opposing lower corner part; and the muffler is secured at three points, i.e., two screws near an exhaust port, and an attachment screw near the upper corner part. Exhaust gas is discharged so as to flow forward along the upper wall surface of the muffler from near the end that is close to the cylinder in the upper surface of the muffler, and the exhaust gas is diffused, with the front corner part (curved surface part) being shaped as a curved surface having a large radius of curvature.

### BACKGROUND OF THE INVENTION

### 1. Field of the Invention

The present invention mainly relates to an engine work machine such as a mower, an air blower, and a chainsaw, or an engine such as a dynamo used as a power resource, in particular to the realization of temperature reduction of the exhaust gas discharged to the outside of a main housing.

### 2. Description of Related Art

In a compact engine work machine, the engine is located near the operator, and high-temperature exhaust gas is discharged from the muffler, so that the muffler is disposed in a manner that the operator does not directly contact with the muffler, or a muffler cover is arranged. Besides, especially in the mower or the chainsaw and so on, due to the standard, the temperature of the exhaust gas discharged outside from the main housing is restricted to a predetermined value. Therefore, the structure which reduces the exhaust gas temperature at the time of discharge from the main housing to the outside becomes important. For example, in patent literature 1, the cooling air generated by a cooling fan is led to the surrounding of the muffler, and the exhaust gas is mixed with the cooling air inside the cover, thereby reducing the exhaust gas temperature. Also, the following technology is known, which arranges a plurality of exhaust outlets which are separated by a distance.

On the hand, in most cases, the muffler is directly screwed and secured to an exhaust port of a cylinder in the compact engine work machine; in this case, an attachment element and a cylinder-shaped collar are secured to the muffler, and are secured by screwing so as to let a screw pass through the inside of the collar which penetrates the inside of an expansion chamber of the muffler. This structure increases the manufacturing steps due to the increasing of the components, therefore leading to not only the cost raise of the compact the muffler, but also an inevitable weight increase. Furthermore, in order to prevent the dust of the work material from heaping in the space of the collar after the screwing and securing, an opening part has to be closed by a cap.

### LITERATURE OF PRIOR ART

### Patent Literature

Patent literature 1: Japanese Laid-open No. 2013-213414

### SUMMARY OF THE INVENTION

### Problems to be Solved by the Invention

As for the technology of patent literature 1, the exhaust gas is mixed with the cooling air, but when the engine work machine requires a reduction in size and weight as the chainsaw, due to the increasing of component numbers and grow in device size, it is difficult to adopt the realization by the structure which leads the cooling air generated by the cooling fan to the surrounding of a muffler. Besides, the solution may be taken in which the distance of the muffler and the muffler cover is increased in the vicinity of the exhaust outlet to sufficiently secure the space volume of the muffler cover near the exhaust outlet part, but this solution makes it difficult for the miniature of the engine work machine.

The present invention is achieved in view of the aforementioned background, and aims to provide an engine and an engine work machine in which the exhaust gas temperature at the time of discharge to the outside of a main housing can be sufficiently reduced. Another objective of the present invention is to provide an engine and engine work machine in which the shape of a muffler is improved to introduce a part of the exhaust gas to a predetermined direction and promotes the mixture with air. Besides, another objective of the present invention is to provide an engine and engine work machine in which a cylindrical collar penetrated by a screw that secures a muffler is not used, instead, the muffler can be secured to a cylinder in the outside part of an expansion chamber.

### Means to Solve the Problems

The characteristics of the typical invention disclosed in this application are as described below. According to one characteristic of the present invention, in an engine which has a cylinder that is connected to a crankcase and forms a combustion chamber, and a muffler secured to the cylinder, the muffler has an outer housing and an inner housing which form the external wall of an expansion chamber, and a partitioning plate which separates the expansion chamber into a first expansion chamber on an inner housing side and a second expansion chamber on an outer housing side, and is a substantial box shape formed by joining them. Seen from an axis direction of the cylinder, the partitioning plate is disposed with a slope so that a distance from the partitioning plate to the cylinder decreases as the partitioning plate gets away from the crankcase, and an exhaust outlet, which discharges the exhaust gas toward the counter-cylinder side along the wall surface of the muffler, is arranged near a cylinder side of the partitioning plate. Besides, in the wall surface where the exhaust outlet is arranged, a muffler corner part on the downstream side in the flowing direction of the exhaust gas is configured so as to have a curvature greater than a curvature of other muffler corner part opposing to the muffler corner part.

According to another characteristic of the present invention, in the wall surface (upper surface) of the outer housing where the exhaust outlet is arranged, the muffler corner part on the downstream side in the flowing direction of the exhaust gas is formed so as to have a curvature greater than another opposing muffler corner part (the corner part on the side near the cylinder of the inner housing). Besides, an inlet which is connected to the exhaust port of the cylinder for the exhaust gas to flow in is formed, and an attachment element with opening part is secured to the muffler so as to encircle the inlet. The attachment element is used to secure a component to the cylinder by a plurality of fastening components, by which the muffler is mounted to the cylinder in the outside part of the expansion chamber only, without passing through the inner space. Furthermore, a second attachment position is configured on the muffler at a position other than the attachment element to secure the muffler to the cylinder by additional fastening components. This second attachment position can be configured by extending the joining part of the outer housing and the inner housing.

According to another characteristic of the present invention, the muffler has a partitioning plate separating the first expansion chamber and second expansion chamber, and is secured by the attachment element secured to the muffler in the outside part of the expansion chamber to the exhaust port of the cylinder by two screws. A case of the muffler is configured to an outer shape which is away from the axis lines of the two screws, the width from the line connecting the two screws to the counter-crankcase side part is configured narrower than the distance between the two screws, and the width from the line connecting the two screws to the crankcase side part is configured wider than the distance between the two screws. Besides, in the counter-crankcase side part (the upper side part of the muffler), the muffler is secured to the cylinder by an additional fastening component such as a third screw.

According to another characteristic of the present invention, the muffler is configured in a way that the first expansion chamber and the second expansion chamber are formed by the partitioning plate in the front-back direction, the surface direction of the partitioning plate is slanted relative to an axis direction of the cylinder, and the partitioning plate becomes nearer to the cylinder as the partitioning plate gets away from the crankcase. Besides, the exhaust outlet is arranged on the surface of the muffler that is near the cylinder and away from the crankcase.

### Effect of the Invention

According to the present invention, the distance from the exhaust outlet of the muffler to the outside of the main housing can be secured to be long as much as possible, and a part of the exhaust gas is introduced to a predetermined direction by the wall surface shape of the muffler and the shape of the main housing, therefore the exhaust gas temperature can be sufficiently reduced by the promotion of mixture with air. Besides, the cylinder-shaped collar passing through the expansion chamber is not used to secure the muffler, manufacturing steps are reduced due to the reduction of component numbers, and the weight can also be reduced. Furthermore, it is not necessary for the collar to penetrate the partitioning plate inside the expansion chamber, the flexibility in design of the shape of the expansion chamber increases, the exhaust gas in the vicinity of the joining part of the collar and the partitioning plate can be prevented from leaking, and in the muffler using a catalyst, the performance of the exhaust gas can be raised.

The aforementioned and other objectives and new characteristics of the present invention are made clear from the description of the specification and the drawings below.

### BRIEF DESCRIPTION OF THE DRAWINGS

FIG. 1 is a left side view of a chainsaw 1 of the working example of the present invention.

FIG. 2 is a partial cross-section view showing the arrangement structure of a cylinder 21 and a muffler 30 of the chainsaw 1 of the working example of the present invention.

FIG. 3 is a vertical cross-section view showing the detailed structure of the muffler 30 in FIG. 2.

FIG. 4 is a perspective view of the muffler 30 in FIG. 2.

FIG. 5 is a front view of the muffler 30 in FIG. 2.

FIG. 6 is a left side view of the muffler 30 in FIG. 2.

FIG. 7 is a back view of the muffler 30 in FIG. 2.

FIG. 8 is a top view of the muffler 30 in FIG. 2.

FIG. 9 is an arrow view of a guide cover 50 of the muffler 30 from the A direction in FIG. 6.

### DESCRIPTION OF THE EMBODIMENTS

### Working Example 1

In the following part, the working example of the present invention is described with reference to the drawings. In the following drawings, a chainsaw is used as an example of an engine work machine for description, the same symbols are marked for the same part and repeated description is omitted. Besides, in this specification, directions of front, back, left, right, up and down are described as the directions shown in the drawings.

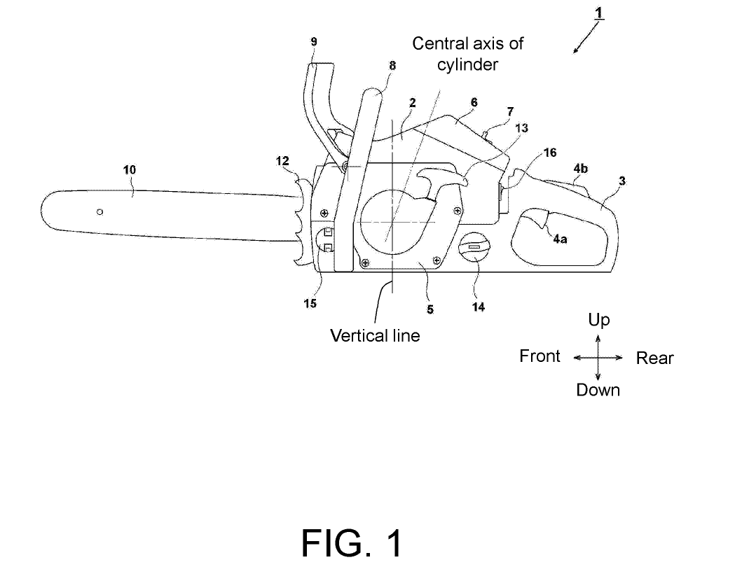

FIG. 1 is a left side view of a chainsaw 1 of the working example of the present invention. The chainsaw 1 uses a 2-cycle engine (described below) to make a saw chain (not shown) which goes around a guide bar 10 rotate at a high speed, thereby cutting the woods or branches and so on. The engine is accommodated in a main housing 2, and the guide bar 10 is disposed so as to extend from the right side surface of the main housing 2 toward the front side. The main housing 2 is a framework part of the chainsaw 1, which not only accommodates the engine, but also attaches the guide bar 10, some kind of cover, or a spike 12 around. A front handle 8 and a rear handle 3 for the operator to grip via a vibration-proof mechanism not shown are arranged on the main housing 2. In the rear handle 3, a throttle lever 4a which operates a carburetor not shown and adjusts the output of the engine, and a lock lever 4b which unlock the throttle lever 4a are arranged. A brake handle (hand guide) 9 is arranged on the front side of the front handle 8, and by taking the brake handle 9 down to the front side, an inner brake (not shown) comes into operation and can immediately stop the rotation of the saw chain. An air cleaner (not shown) is arranged inside the main housing 2 on the upper side, and is covered by an air cleaner cover 6 which can be removed by a fixing screw 7.

In the engine that is not shown, inside the main housing 2, a crankshaft (not shown) extending in a horizontal direction perpendicular to the front-back direction of the chainsaw 1 is disposed, and a cooling fan (not shown) is arranged on the left side end of the crankshaft and is covered by a recoil starter 5. On the rear side of the left side surface of the main housing 2, a fuel injection opening 14 of a fuel tank (not shown) supplied to the engine is arranged, and on the front side of the left side surface, a chain oil injection opening 15 of the tank for oil supplied to the saw chain is arranged. FIG. 1 shows the state in which caps are arranged respectively on the injection openings 14, 15. A starter handle 13 is arranged on the recoil starter 5, when the operator draws the starter handle, the engine starts, and when the throttle lever 4a is drawn in the state in which the rear handle 3 is gripped and the lock lever 4b is pressed down, the rotation of the engine increases, and the rotation force of the engine is transferred by the connection of a centrifugal clutch not shown, leading to the rotation of the saw chain (not shown). In the wall surface on the rear side of the main housing 2, a stop switch 16 for stopping the operating engine is arranged.

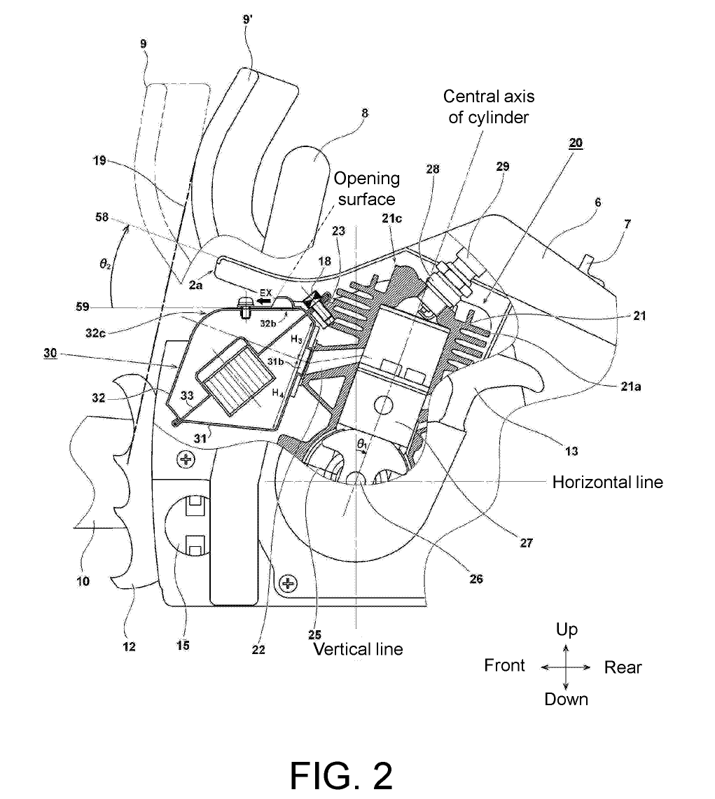

FIG. 2 is a partial cross-section view (vertical cross-section view) showing the arrangement structure of the cylinder 21 of the chainsaw 1 and the muffler 30 of the working example of the present invention. The engine 20 is horizontally disposed so that a crankshaft 26 extends in the horizontal direction inside a crankcase 25, and a piston 27 moves back and forth in the upper cylindrical space of the engine 20. A plurality of heat-releasing fins 21a are formed outside of the vicinity of the combustion chamber of the cylinder 21, an exhaust port 22 is arranged on the front side, and a suction port (not illustrated) is arranged on the rear side. The cylinder 21 is attached to the crankcase 25, and the central axis is disposed so as to extend in the substantial vertical direction; however, here, the cylinder 21 is disposed with a slope so that the central axis of the cylinder 21 has a predetermined angle θ₁ on the rear side of the vertical line. By disposing the cylinder 21 with a slope in this way, as the upper end position 21c of the cylinder 21 moves slightly downward, the distance with the front handle 8 increases, so that the miniature of the body is realized, and the operability is also excellent. The brake handle 9 shown by the two-dot chain line is in the position of normal operation, moves toward the front side during a braking (not shown), and gets to the position of the brake handle (rear end position) 9′ shown by the solid line when moving toward the side nearest to the engine 20.

By slanting the cylinder 21 to the rear side, the space occupied by the muffler 30 in the main housing 2 can be secured to be large, and the distance between the outside of the main housing 2 and the exhaust outlet can be large. In this working example, the muffler 30 with a characteristic shape is disposed in this space. A spark plug 28 is arranged on the upper side (counter-crankcase side) of the cylinder 21, a high-pressure current from the ignition coil that is not shown is supplied to the spark plug 28 via a high-pressure cord that is not shown and a plug cap 29.

On the front side (counter-cylinder side) of the engine 20, the muffler 30 is attached which is a substantial box shape that is approximate to a rhombus in a side view. The muffler 30 is directly attached to the exhaust port 22 of the cylinder 21, screwed and secured to the formation part of the exhaust port 22 near the exhaust port 22 of the cylinder 21 by two screws (not shown), and is further secured by an attachment screw 18 to a screw boss 23 formed in a part of the heat-releasing fin 21a of the cylinder 21. Here, the screw is used as the fastening component for securing the muffler 30 to the cylinder 21, but other fastening components such as a rivet may also be used. Besides, the inlet 31b, which is located on the rear surface side (the side facing the cylinder 21) of the inner housing 31 for the exhaust gas to flow in from the exhaust port 22, is disposed so as to lean to the upper side, by satisfying the relationship of height H₃<H₄, the space on the lower side (the crankcase side) of the exhaust port 22 of the cylinder 21 is secured to be large.

The outlet (opening surface) of the exhaust gas EX in the muffler 30 is opened so as to face the front side, and the exhaust gas EX flows to the front side along the wall surface on the upper side of the muffler 30. The distance between the main housing 2 and the muffler 30 is set to a predetermined distance, so that the radiation heat of the muffler 30 is hard to be transferred to the main housing 2 made by synthetic resin. In this case, by adjusting the size of the space, the direction of the exhaust gas EX smoothly diffuses upward, and is discharged from the lower side of the upper front end part 2a of the main housing 2 to the front side. The shape of the inner wall surface of the main housing 2 is set to a shape in which the wall surface rises upward while moving frontward from the vicinity of the attachment screw 18 and the distance with the muffler 30 increases, and the exhaust gas EX can be sufficiently diffused upward while moving to the downstream side. Here, the angle between an imaginary line 58 which is the extending line of the inner wall surface of the main housing 2 and an imaginary line 59 of the inner wall surface of the main housing 2 above the muffler 30 is enlarged to θ₂=20°.

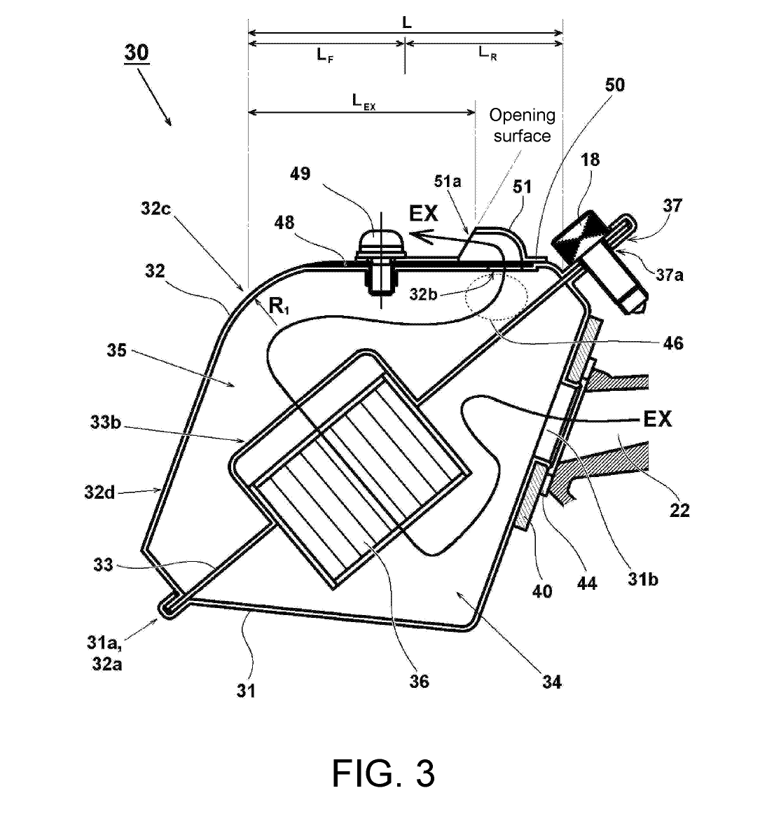

The outlet of the exhaust gas EX (the exhaust outlet 51a described below with FIG. 3) is disposed on the rear side (cylinder side) of the upper wall surface of the muffler 30. In this way, the exhaust gas EX is discharged from the rear side of the upper wall surface and flows to the front side along the upper wall surface, by which the distance of the exhaust gas flowing along the outer edge part of the main housing becomes long, and the distance from the vicinity of the front end part to the position where the exhaust gas is discharged to the outside of the main housing 2 can be long enough. As a result, the temperature of the exhaust gas EX at the time of discharge to the outside of the outer edge part can be sufficiently reduced. In particular, at the time when the exhaust gas EX gets to an imaginary line 19 shown by a two-dot chain line, a state in which the temperature is low enough is achieved. According to such a structure, the fear of the cutting object such as logs positioned on the front side being influenced by heat can be reduced. In this working example, in order to further increase the diffusion effect of the exhaust gas EX, the shape of the corner part (a curve part 32c), which is near the position where the exhaust gas EX flowing along the upper wall surface of the muffler 30 departs from the muffler 30, has a great curvature radius. Therefore, the exhaust gas EX easily flows along the wall surface shape and bends downward near the curve part 32c, so that a part of the exhaust gas EX is introduced not only to the upper side on the front side of the muffler 30 but also introduced downwardly, therefore, the exhaust gas EX can be further diffused.

Next, FIG. 3 is used to describe the structure of the muffler 30 screwed to the cylinder 21. FIG. 3 is an enlarged cross-section view of only the muffler 30 in FIG. 2. The muffler 30 is formed by joining the separate opening parts of the inner housing 31 near the cylinder 21 and the outer housing 32 away from the cylinder 21 as a shellfish does, and the outer edge section 31a of the inner housing 31 is folded to the outer edge section 32a formed on the outside and swaged to a substantial box shape. In this case, the outer edge section 32a of the outer housing 32 and the outer edge section 31a of the inner housing 31 are joined together with the outer edge part of the partitioning plate 33 in-between, thereby defining the first expansion chamber 34 which communicates with the exhaust port 22 of the cylinder 21, and the second expansion chamber 35 which becomes the exhaust outlet side where the exhaust gas is discharged to the air. Besides, the opening (suction opening) 31b of the first expansion chamber 34 is directly connected to the cylinder 21. In the expansion chamber, the first expansion chamber 34 and the second expansion chamber 35 are formed in the front-back direction by the partitioning plate 33. The partitioning plate 33 is slanted so that the surface direction is tilted from the axis direction of the cylinder 21, and is disposed so that as the partitioning plate 33 moves upward (to the side away from the crankcase), the distance with the cylinder 21 becomes shorter and shorter.

Between the first expansion chamber 34 and the second expansion chamber 35, a catalyst 36 for purifying the exhaust gas is arranged, and the exhaust gas EX passes through the catalyst 36 arranged in the concave 33b of the partitioning plate 33 and flows from the first expansion chamber 34 toward the second expansion chamber 35 side. In the part of the concave 33b opposing the outlet surface of the catalyst 36, a plurality of through holes (which cannot be seen in the cross-sectional position of the drawing) which the exhaust gas passes through are opened. The partitioning plate 33 can be manufactured by pressing an iron plate or stainless plate for example. The exhaust gas expanded by the second expansion chamber 35 passes through the discharge opening 32b from a narrowed space 46 behind the upper wall surface of the second expansion chamber 35 and flows to the guide cover 50 side, then passes through the exhaust outlet 51a of the exhaust passage 51 and is discharged to the front side.

The exhaust passage 51 is formed by the guide cover 50, i.e. an exhaust gas regulating component attached to the outer wall surface of the outer housing 32, and determines the discharging direction of the exhaust gas, the pipe-shaped path formed by the exhaust passage 51 extends forward, and the exhaust outlet 51a is formed at the end of the path. The guide cover 50 is a component fixed to the outer housing 32, and serves to hold a metallic mesh shaped spark arrester 48 near the discharge opening 32b of the outer housing 32. The spark arrester 48 is inserted between the guide cover 50 and the outer housing 32 from the front side, and is held by a screw 49 so as not to fall. The exhaust passage 51 is formed by pressing a metallic plate, and due to the shape of the exhaust passage 51, the exhaust gas EX is discharged to the front side (the counter-cylinder side) so as to flow in a predetermined direction along the upper wall surface of the outer housing 32 (the guide cover 50).

In the attachment part on the cylinder 21 side of the muffler 30, a thick-plate shaped attachment element 40 is arranged. The attachment element 40 is fixed to the muffler 30 side by welding and so on, and the muffler 30 is screwed to the cylinder 21 on the basis that a gasket 44 exists between the attachment element 40 and the cylinder 21. In addition, the screw mentioned in this specification is not limit to a plus screw or minus screw, and may be a bolt, a push-fit pin-shaped component or other fixing component as long as it is a fastening component which secures the attachment element 40 and the cylinder 21. The gasket 44 is graphitic sheet for example, and is used to improve the adhesion between the muffler 30 and the exhaust port 22 of the cylinder 21, but it also acceptable to remove the gasket 44 and secure the muffler 30 to the cylinder 21. Here, as for the external wall surface on the upper side (counter-crankcase side) of the muffler 30, the distance from the rear side (cylinder side) to the front side (the counter-cylinder side) becomes L, comprising a front half L_{F} and a rear half L_{R}. In this distance, the part for which the exhaust gas EX flows is L_{EX}. The L_{EX} includes the front half L_{F} and extends till the rear half L_{R}. That is, the outlet of the exhaust gas EX, i.e. the exhaust outlet 51a is disposed with a slope on the rear side (the cylinder side) of the upper wall surface of the muffler 30. The corner part (the muffler corner part) on the front side of the upper external wall surface of the muffler 30 is set to the curve part 32c, which forms a gentle curve with a sufficiently large curvature radius R₁.

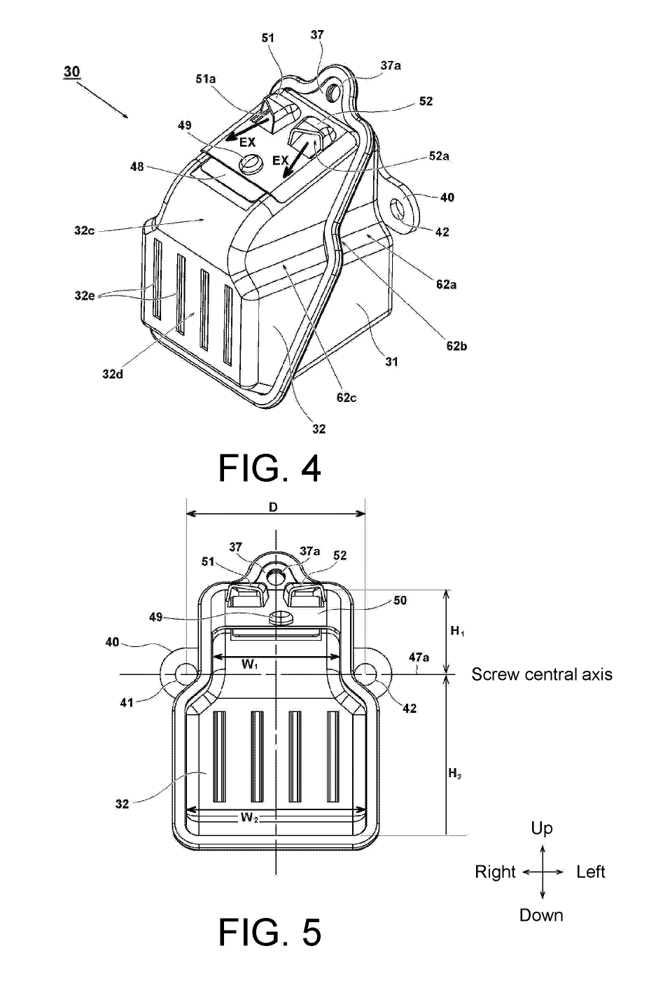

FIG. 4 is a perspective view of the muffler 30. The muffler 30 of this working example is located completely outside, the screw for the attachment to the cylinder 21 not penetrating the inner space (the expansion chamber) of the muffler 30. Accordingly, the cylindrical collar used in the conventional muffler for screwing does not exist. Therefore, the cap for filling the opening part of the collar is also unnecessary, the component numbers are reduced and reduction of manufacturing steps and weight can be achieved. Besides, the expansion chamber of the muffler 30 is formed by joining the inner housing 31 and the outer housing 32, it is unnecessary to open a through hole in the partitioning plate 33 for passing the collar; therefore, there is no fear of existence of clearance in the joining part of the collar and the partitioning plate 33, and the leakage of exhaust gas between the expansion chambers can be prevented. Furthermore, when the catalyst 36 is used, the fixing position of the catalyst 36 to the partitioning plate 33 is not limited by the position of the collar, so that in the muffler 30 of this working example, the catalyst with a large size can be used, and the leakage of exhaust gas between the expansion chambers is prevented; as a result, the performance of exhaust gas treatment can be improved.

On the lateral surfaces on the left and right sides of the muffler 30, bending parts 62a, 62b, 62c are formed so as not to interfere with the outer housing 32 and the inner housing 31 during the attachment of the screw that is not shown. The bending parts 62a, 62b, 62c are the parts which refuge the case of the muffler 30, i.e. the external wall of the expansion chamber, to the inner side, so that the inner housing 31 and the outer housing 32 are not located on the axis line of the screw. On the cylinder 21 side of the bending parts 62a, 62b, 62c, an attachment element 40 is arranged, which is formed so as to protrude more in the horizontal direction than the inner housing 31. Screw holes 41 (see the following FIG. 5), 42 are formed in the attachment element 40. By forming the bending parts 62a, 62b, 62c, the screw that is not shown can be easily secured by a tool such as a driver, so that the assembling operability is improved. Besides, in the vicinity of the upper center of the joining part of the muffler 30, a flange 37 for forming a screw hole 37a is formed, which is screwed to the cylinder 21 by an attachment screw 18 (see FIG. 3) using the screw hole 37a as a second attachment position (an additional attachment position). In addition, the method for fixation to the second attachment position is not limited to the method using the attachment screw, and the fixation can also be done by a rivet, by pressing or by using other fastening components.

In the part of the outer housing 32 where the upper wall surface is formed, the guide cover 50 is arranged. And the guide cover 50 is configured to be attachable by a screw 49 to a component where two exhaust passages 51, 52 that are disposed substantially in parallel with the guide cover 50 are formed. The opening of the exhaust passages 51, 52, i.e. the exhaust outlets 51a, 52a are formed with a slope so that the normal line of each opening slants downward in the top view. Because the exhaust passages 51, 52 which determine the exhaust gas direction of the exhaust gas EX are arranged on the guide cover 50 in this way, various exhaust gas directions and exhaust gas states can be achieved by changing the shape of the guide cover 50 only, without changing the shape of the outer housing 32 of the muffler 30. A plurality of beads 32e extending vertically is formed in the front surface part 32d on the front side of the outer housing. The beads 32e are used for a reinforcement which improves the rigidity. The upper part of the front surface part 32d is connected to an upper surface wall formed to a plate shape by the curve part 32c which forms a gentle curve.

FIG. 5 is a front view of the muffler 30. Here, the upper side of the screw central axis 47a, which connects the centers of the two screw holes 41, 42 for fixing the muffler 30 to the exhaust port 22, becomes a width W₁ narrower than the inner side distance of the screws. On the other hand, the lower side of the muffler 30 below the screw central axis 47a becomes a width W₂ narrower than the inner side distance of the screws. The upper side (counter-crankcase side) width W₁ of the muffler 30 is narrower than a distance D of the two screw holes 41, 42, which is perpendicular to the axis direction of the cylinder 21, the two screw holes 41, 42 being used for fixing the attachment element 40 to the exhaust port 22. Similarly, the muffler 30 is formed in a manner that seen from the height direction, compared with the height H₁ of the expansion chamber on the upper side of the screw central axis 47a which connects the centers of the two screw holes 41, 42 (the outer edge section 31a part is neglected because of the little influence on the volume of the expansion chamber), the height H₂ of the expansion chamber on the lower side (crankcase side) of the screw central axis 47a is higher. Compared with the conventional engine, in the muffler 30 of the engine 20 in this working example, the distance D between the screw holes of the attachment element 40 on two sides of the exhaust port is widely formed. However, if the distance D is too large, the adhesion around the exhaust port 22 becomes poor, and the possibility of exhaust gas leakage becomes high, therefore there is a limit in widening the distance D. For this reason, in this working example, the expansion chamber volume of the muffler 30 on the lower side of the screw central axis 47a is formed large, and the expansion chamber volume necessary for the muffler 30 is sufficient. In recent years, the situation increases in which the muffler 30 contains a catalyst due to the exhaust gas regulation, and in the muffler 30 of this working example, the catalyst 36 (see FIG. 3) can be accommodated in the large space (expansion chamber) with a width W₂ on the lower side of the screw central axis 47a. Moreover, there is no cylinder-shaped collar in the expansion chamber, so that large catalyst can be installed due to reduced regulation on the arrangement of the catalyst 36. Furthermore, because exhaust gas leakage inside the expansion chamber is prevented since there is no collar, the performance of exhaust gas treatment of the exhaust gas EX is improved.

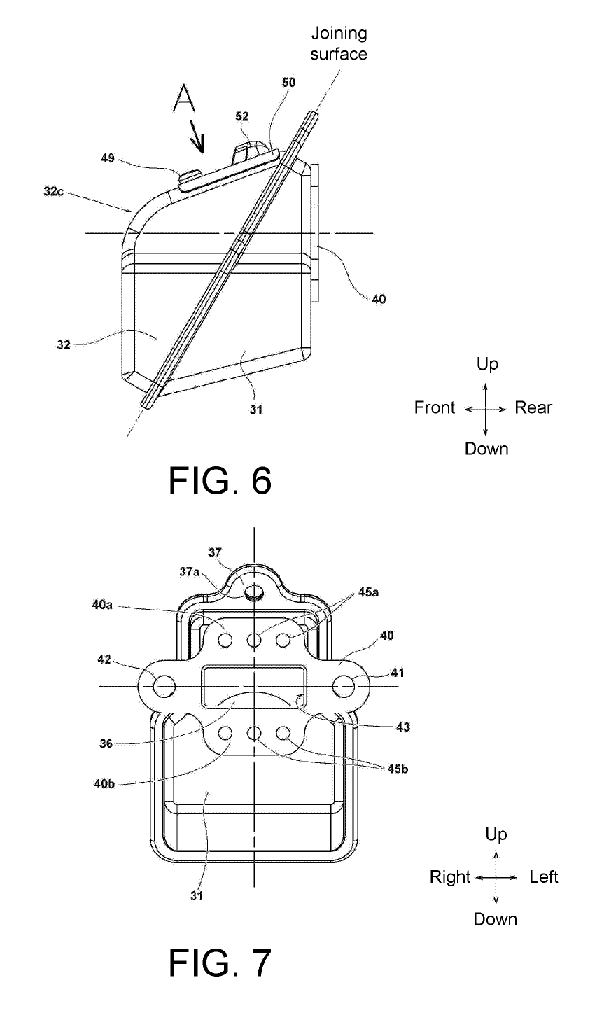

FIG. 6 is a left side view of the muffler 30. The shape of the muffler 30 is simple, and is made to a box shape by overlapping the shellfish-shape inner housing 31 and outer housing 32 which are made by pressing the metallic plate in a way that the opening parts of the housings overlap with each other, and swaging the outer edge part. After the swaging operation, the thick-plate shaped attachment element 40 is secured to the inner housing 31 by spot welding and so on. The guide cover 50 is secured to the outer housing 32, and a spark arrester (see FIG. 3) exists between the guide cover 50 and the outer housing 32. The spark arrester is fixed by securing the screw 49. Here, the position of the center axis line of the screw secured to the attachment element 40 is represented by a one-dot chain line.

Conventionally, as for the muffler 30, if the cylinder-shaped collar through which the screw penetrates is disposed in the expansion chamber, the collar is disposed in the position of the screw center axis line represented by the one-dot chain lien. However, in this case, the collar interferes with the curve part 32c of the outer housing 32, furthermore, the collar intersects with the internal partitioning plate with a slope; therefore, it is difficult to perform the so-called burring, i.e. the rising processing around the through hole in order to prevent the exhaust gas leakage prevent. Accordingly, in the conventional muffler, the partitioning plate and the collar are also disposed so as to be perpendicular. Furthermore, in the conventional muffler, the joining surface is disposed so as to be perpendicular to the screw center axis line. On the contrary, for the muffler 30 of this working example, the screw does not penetrate into the space inside the expansion chamber, so there is no need for the collar to penetrate. Accordingly, the housing shape of the expansion chamber of the muffler 30 or the position of the joining surface can be disposed with high flexibility, and it is easy to dispose the joining surface diagonally to the center axis line of the screw.

FIG. 7 is a back view of the muffler 30. On the wall surface on the rear side (cylinder side) of the muffler 30, the attachment element 40 with an extending part is arranged in order to fix the screw holes 41, 42 to the left and right side parts in the short side of the rectangular inlet 43. On the upper side and lower side of the long side of the inlet 43 in the attachment element 40, extending parts 40a, 40b that convexly protrude upward and downward are formed so as to have a predetermined contacting area for the fixation to the wall surface of the inner housing 31, and in the extending parts 40a, 40b, spot welding 45a, 45b are performed in a plurality of positions, and it being three positions in this example. Among the part made by overlapping and joining the outer housing 32 with the inner housing 31 and the partitioning plate 33, in the position near the upper left and right center, a flange 37 with a predetermined area is formed, and a screw hole 37a is formed in the center of the flange 37. The flange 37 becomes the screw seat and ensures the predetermined flat area. In this way, the muffler 30 is fixed to the cylinder 21 by three screws (not shown), and the axis directions of these screws are located in the outside region, completely not interfering with the inner space (the part of the expansion chamber) of the muffler 30, so that the muffler 30 with high flexibility in design can be realized without reducing the volume of the expansion chamber.

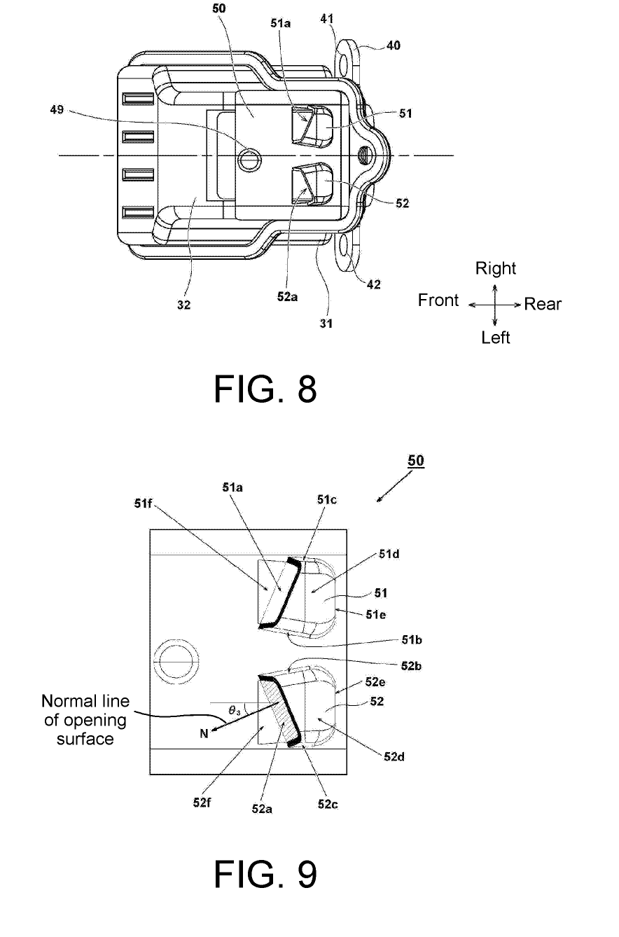

FIG. 8 is a top view of the muffler 30. Here, the guide cover 50 having two exhaust passages 51, 52 are fixed by welding so as to cover the rear half of the upper wall part of the muffler 30. In the guide cover 50, two exhaust passage 51, 52 are arranged, which have paralleled surfaces which are parallel with the upper wall part of the muffler 30 that extends in parallel with the discharged exhaust gas EX, and sides walls extending in the direction intersecting with the paralleled surfaces. According to this drawing, it can be understood that the direction of the exhaust outlet 51a of the exhaust passages 51, 52 expands leftward and rightward

FIG. 9 is a top view of only the guide cover 50 of the muffler 30, and is an arrow view from the A direction in FIG. 6. The guide cover 50 has a size which covers about the rear half of the upper wall when seen from the top of the muffler 30, and two exhaust passages 51, 52 are formed therein. In the guide cover 50, two exhaust passages 51, 52 are formed, which have: paralleled surfaces (upper surfaces 51d, 52d), which extend in the direction parallel to the discharged exhaust gas EX, and are parallel to the upper wall surface of the outer housing 32; two lateral wall surfaces (51b, 51c, 52b, 52c), which extend in the direction interesting with the paralleled surfaces; and rear wall surfaces (rear surfaces 51e, 52e), which close the rear side of the paralleled surfaces and the lateral surfaces. By being attached to the outer wall surface of the outer housing 32, the exhaust passages 51, 52 become passages that determine the discharge direction of the exhaust gas EX. Due to the path shape of the exhaust passage 51 and the angles of the opening surfaces of the exhaust outlets 51a, 52a, the exhaust gas EX flows forward (in the direction perpendicular to the axis direction of the cylinder 21) along the upper wall surface of the outer housing 32.

The size of the guide cover 50 is sufficiently larger than the discharge opening 32b (shown by the dotted line in FIG. 4) of the outer housing 32 (see FIG. 2), and the end positions of the exhaust passages 51, 52 in the horizontal direction are formed so as to be beyond the left and right positions of the discharge opening 32b in the left and right side. Besides, the end positions of the exhaust passages 51, 52 in the rear direction are formed so as to be beyond the rear end position of the discharge opening 32b in the rear side. Here, in the front side of the exhaust outlet 52a shown by a slanted line, a removed part 52f which is substantially triangular in the top view is formed (also formed on the exhaust passage 51 side in the same way). This is arranged in order to improve the processability to form the exhaust passage 52 by pressing, and because the shape of this removed part 52f has little influence on the discharge of the exhaust gas EX, it is optional whether to arrange the removed part 52f. For the determination of the discharge direction of the exhaust gas EX, the direction (the direction of the normal line of the opening surface) of the exhaust outlet 52a whose opening surface is shown by the slanted line is particularly crucial; here, the direction N of the normal line in the top view is formed so as to be leftward from the front for an angle θ₃. The exhaust passage 52 of the muffler 30 is disposed so that the front end part of the inner lateral wall surface 52b is located on the downstream side of the front end part of the outer lateral wall surface 52c in the discharge direction of exhaust gas, moreover, the exhaust passage 52 of the muffler 30 is disposed so that the lower end of the front end part of the inner lateral wall surface 52b is located on the downstream side of the upper end of the front end part of the outer lateral wall surface 52c in the discharge direction of exhaust gas. Here, because the exhaust passage 51 side is bilaterally symmetric to the exhaust passage 52 side, the same applies to the shape on the exhaust passage 51 side. By forming the guide cover 50 in this way, the exhaust gas EX can be diffused in not only the horizontal direction but also the upward direction, the mixture with the air is promoted in a wider scope, and the exhaust gas temperature can be reduced.

According to this working example, because the upper end part of the partitioning plate 33 is slanted so as to get close to the cylinder 21, and the discharge opening 32b is formed near the upper end part, reduction of exhaust gas temperature can be realized. Besides, because the muffler 30 is not fixed by a cylinder-shaped collar, reduction of assembling steps and the weight reduction of the muffler 30 can be realized due to the decrease of component numbers. Furthermore, because collar is not used, the arrangement flexibility of inner components in the muffler, in particular the one using a catalyst, can be greatly increased. Furthermore, limitations in design such as the necessity of setting the wall surface contacting with the collar opening to a flat surface are solved, so that the flexibility in design of the muffler shape can be greatly increased.

In the above, the present invention is described based on the working example, but the present invention is not limited to the working example and can be modified without departing from the spirit. For example, in the abovementioned working example, a chainsaw driving a saw chain is used for description as the work machine driven by an engine, but the present invention can be applied to various portable engine work machines such as a blower, a cutter, a mower and universal engines without being limited to the chainsaw only.

### REFERENCE SIGNS LIST

1 Chainsaw
2 Main housing
2a Upper front end part
3 Rear handle
4a Throttle lever
4b Lock lever
5 Recoil starter
6 Air cleaner cover
7 Fixing screw
8 Front handle
9 Brake handle
9′ Brake handle (rear end position)
10 Guide bar
12 Spike
13 Starter handle
14 Fuel injection opening
15 Chain oil injection opening
16 Stop switch
18 Attachment screw
19 Imaginary line
20 Engine
21 Cylinder
21a Heat-releasing fin
21c Upper end position (of cylinder)
22 Exhaust port
23 Screw boss
25 Crankcase
26 Crankshaft
27 Piston
28 Spark plug
29 Plug cap
30 Muffler
31 Inner housing
31a Outer edge section
31b Inlet
32 Outer housing
32a Outer edge section
32b Discharge opening
32c Curve part
32d Front surface part
32e Bead
33 Partitioning plate
33b Concave
34 First expansion chamber
35 Second expansion chamber
36 Catalyst
37 Flange
37a Screw hole
40 Attachment element
40a, 40b Extending part
41, 42 Screw hole
43 Inlet
44 Gasket
45a, 45b Spot welding
46 Space
47a Screw central axis
48 Spark arrester
49 Screw
50 Guide cover
51, 52 Exhaust passage
51a, 52a Exhaust outlet
51b, 52b Lateral surface
51c, 52c Lateral surface
51d, 52d Upper surface
51, 52e Rear surface
51f, 52f Removed part
59 Imaginary line
62a, 62b, 62c Bending part
EX Exhaust gas

1. An engine, comprising: a cylinder, which is connected to a crankcase and forms a combustion chamber; and a muffler, which is secured to the cylinder;
wherein the muffler comprises: an outer housing and an inner housing, which form an external wall of an expansion chamber; and a partitioning plate, which separates the expansion chamber into a first expansion chamber on an inner housing side and a second expansion chamber on an outer housing side; and the muffler is a substantial box shape formed by joining the outer housing and the inner housing with the partitioning plate; seen from an axis direction of the cylinder, the partitioning plate is disposed with a slope so that a distance from the partitioning plate to the cylinder decrease as the partitioning plate gets away from the crankcase;
the outer housing comprises an upper wall surface, and
an exhaust outlet is disposed on a cylinder side of the upper wall surface and discharges an exhaust gas toward a counter-cylinder side along a wall surface of the muffler.

2. The engine according to claim 1, wherein in the wall surface where the exhaust outlet is arranged, a muffler corner part on a downstream side of a flowing direction of the exhaust gas is configured so as to have a curvature larger than a curvature of other muffler corner part opposing to the muffler corner part.

3. The engine according to claim 2, wherein the muffler comprises an inlet which is connected to an exhaust port of the cylinder and into which the exhaust gas flows, an attachment element comprising an opening part is secured to the muffler so as to encircle the inlet, the attachment element is secured by a plurality of fastening components to the cylinder, and the fastening components are installed to an outside part of the expansion chamber.

4. The engine according to claim 3, wherein as for the muffler, a width of the expansion chamber on a counter-crankcase side from a line connecting central axes of the plurality of fastening components is narrower than a width of the expansion chamber on a crankcase side.

5. The engine according to claim 3, wherein a second attachment position is configured on the muffler at a position other than the attachment element for securing the muffler to the cylinder by an additional fastening component.

6. The engine according to claim 5, wherein the second attachment position is configured by extending a joining part of the outer housing and the inner housing.

7. An engine, comprising: a cylinder, which is connected to a crankcase and forms a combustion chamber; and a box-shaped muffler, which is attached to the cylinder;
wherein the muffler comprises a partitioning plate separating a first expansion chamber from a second expansion chamber, and is secured to an exhaust port of the cylinder by two screws in an outside part of an expansion chamber by an attachment element secured to the muffler, a case of the muffler is configured so as to keep away from axis lines of the two screws, a width from a line connecting the two screws to a counter-crankcase side part is configured narrower than a distance between the two screws, and a width from the line connecting the two screws to a crankcase side part is configured wider than the distance between the two screws.

8. The engine according to claim 7, wherein in the counter-crankcase side part, the muffler is secured to the cylinder by an additional fastening component.

9. The engine according to claim 7, wherein the muffler is configured so that the first expansion chamber and the second expansion chamber are formed in a front-back direction by the partitioning plate, a surface direction of the partitioning plate is slanted relative to an axis direction of the cylinder, and a distance from the partitioning plate to the cylinder decreases as the partitioning plate gets away from the crankcase; and an exhaust outlet is arranged on a surface of the muffler which is close to the cylinder and away from the crankcase.

10. The engine according to claim 9, wherein in a wall surface where the exhaust outlet is arranged, a muffler corner part on a downstream side in a flowing direction of an exhaust gas is configured so as to have a curvature larger than a curvature of other muffler corner parts.

11. The engine according to claim 7, wherein the muffler comprises a catalyst in the expansion chamber, and the catalyst is disposed on the crankcase side part of the line connecting the two screws.

12. An engine work machine using the engine according to claim 1 to drive a work machine.
